(19) United States
(12) Patent Application Publication
(10) Pub. No.: US 2006/0289576 A1
(43) Pub. Date: Dec. 28, 2006

(54) Food holder for use in vehicles

(76) Inventor: George P. Krusell, Grimsby (CA)

Correspondence Address: GOWLING, LAFLEUR HENDERSON LLP, ONE MAIN STREET WEST, HAMILTON, ON, L8P 4Z5, CA

(21) Appl. No.: 11/437,782

(22) Filed: May 22, 2006

Related U.S. Application Data
(60) Provisional application No. 60/685,408, filed on May 31, 2005.

(51) Int. Cl. B60R 7/00

(52) U.S. Cl. 224/276

(57) ABSTRACT

A food holder for use in a vehicle has a rear wall and a front wall hingedly connected at their bottom ends for movement between a closed position in which the walls are adjacent and substantially parallel to each other and an open position in which the walls diverge upwardly away from each other. The food holder also has a pair of foldable side walls, each side wall extending between the front wall and the rear wall at respective ends thereof. The side walls are in a folded condition when the front end rear walls are in the closed position and an unfolded condition when the front and rear walls are in the open position.

### RELATED APPLICATION

This application claims priority from U.S. Provisional Patent Application No. 60/685,408 filed May 31, 2005.

### FIELD IF INVENTION

This invention relates to food holders for use in vehicles

### BACKGROUND OF INVENTION

It has become common practice now a days for a driver of a vehicle to purchase food at a fast food establishment and eat the food while sitting in the vehicle. It is very likely that, while the food is being eaten, pieces thereof and sources and juices therefrom may fall into the lap of the eater. Although paper napkins can be used to catch such falling food, there is still a likelihood of the food falling onto the clothing of the eater, especially on the chest area and producing a stain thereon. There is a certain awkwardness associated with the attendant joggling which lessens enjoyment of the repast

It is therefore an object of the present invention to provide a food holder which can be used to avoid these problems and maintain cleanliness of automobile and person.

### SUMMARY OF INVENTION

According to the present invention, a food holder for use in a vehicle has a rear wall and a front wall hingedly connected at their bottom ends for movement between a closed position in which the walls are adjacent and substantially parallel to each other and an open position in which the walls diverge upwardly away from each other. The food holder also has a pair of foldable side walls, each side wall extending between the front wall and the rear wall at respective ends thereof, the side walls being in a folded condition when the front end rear walls are in the closed position and an unfolded condition when the front end rear walls are in the open position.

The invention enhances enjoyment of eating in a vehicle, in part by eliminating ennui from joggling and worrying about debris, etc.

When used by a driver of a vehicle, the food holder is placed in the open condition in front of the driver so that the front wall rests against the steering wheel and the rear wall is adjacent the chest of the driver so that, while the driver is eating food, any dropped food, sauces or juices are caught by the food holder.

The front wall may be provided with a retainer engageable with the steering wheel to retain the front wall in a position adjacent thereto. The retainer may be an elongated flexible member, such as a cord.

The front rear and side walls may be formed of cardboard so that the food container is inexpensive to produce and can be discarded after a single use.

### DESCRIPTION OF THE DRAWINGS

One embodiment of the invention will now be described, by way of example, with reference to the accompanying drawings, of which:

FIG. 1 is a perspective view of a food holder in accordance with one embodiment of the invention, the food holder being in an open condition;

FIG. 2 is a similar view showing the food holder mounted on the steering wheel of a car in a folding condition, the open position being shown in dotted outline;

FIG. 3 is a similar view showing the food holder in the open condition and containing various items of food; and

FIG. 4 is a side view showing the food holder in use by the driver of a vehicle.

### DESCRIPTION OF PREFERRED EMBODIMENT

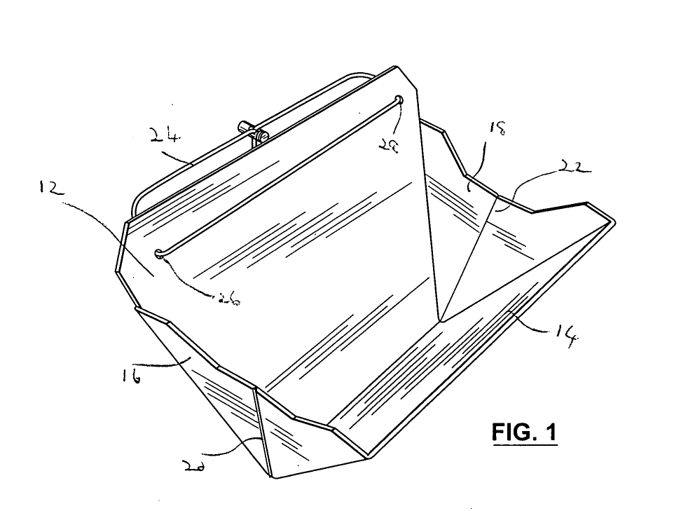

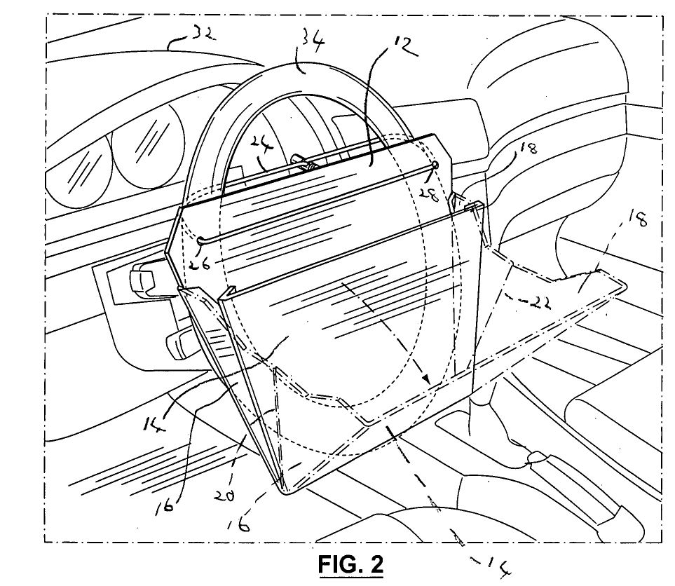

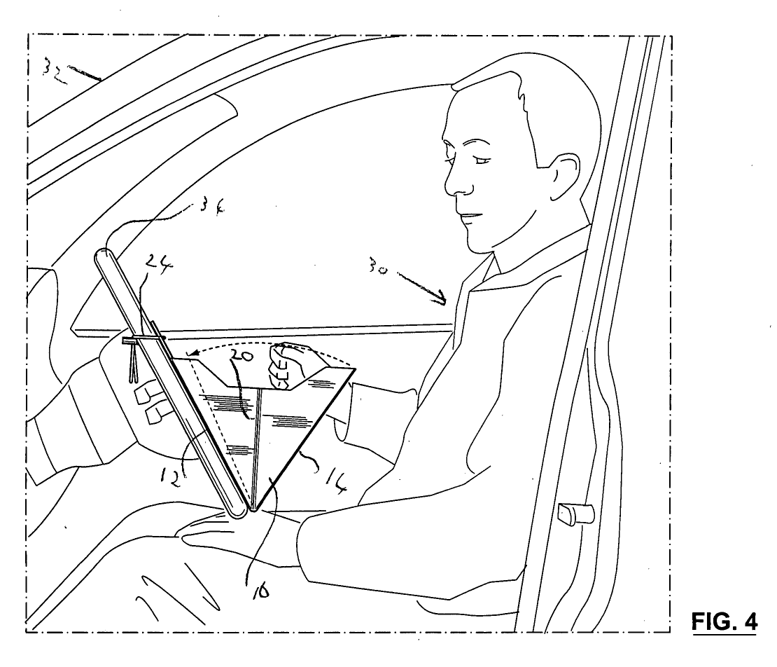

Referring to the drawings, a food holder is made of cardboard and has a front wall 12 and a rear wall 14 ingedly connected at their bottom ends for movement between a closed position (as shown in FIG. 2) in which the front and rear walls 12, 14 are adjacent and substantially parallel to each other and an open position in which the front and rear walls 12, 14 diverge upwardly away from each other (as shown in FIGS. 1, 3 and 4 and in dotted outline in FIG. 2).

A pair of flexible side walls 16, 18 each extend between the front wall 12 and the rear wall 14 at respective ends thereof. The side walls 16, 18 each have a central vertical fold line 20, 22 respectively, thereby rendering them flexible. When the front and rear end walls 12, 14 are in the closed position shown in FIG. 2, the side walls 16, 18 are in an inwardly folded position. When the front and rear end walls 12, 14 are in the open position, the side walls 16, 18 are in an unfolded position, see for example FIG. 1.

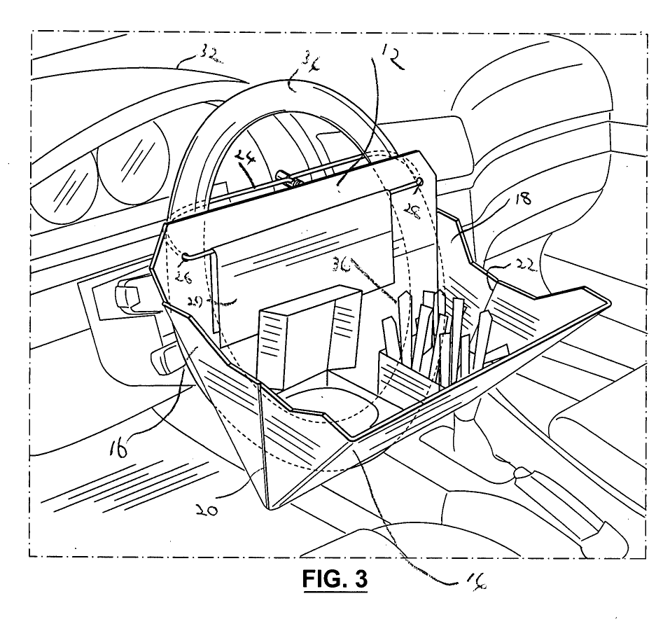

The front wall 12 is provided with a retainer in the form of a cord loop 24 which extends along the front face of the front wall 12, then rearwardly through holes 26, 28 in the front hole 12 and along the rear face thereof. A napkin 29 may be folded over the inner part of the cord loop 24, as shown in FIG. 3.

When in use by the driver 30 of a vehicle 32, the food holder is placed in the open position in front of the driver, with the cord loop 24 over the steering wheel 34 to retain the front wall 12 adjacent thereto. The food holder cannot only contain food 36 purchased by the driver but can also function to catch food which the driver 30 may drop.

Because of the foldable capability, food holders in accordance with the invention can be conveniently stored and, if desired, supplied with the food. Likewise, they may be discarded after use in the same manner as the food containers and left over food are conventionally discarded.

Other advantages of the invention and embodiments thereof will now be readily apparent to a person skilled in the art, the scope of the invention being defined in the appended claims.

1. A food holder for use in a vehicle having a rear wall and a front wall hingedly connected at their bottom ends for movement between a closed position in which the walls are adjacent and substantially parallel to each other and an open position in which the walls diverge upwardly away from each other, and a pair of foldable side walls, each side wall extending between the front wall and the rear wall at respective ends thereof, the side walls being in a folded condition when the front end rear walls are in the closed position and an unfolded condition when the front and rear walls are in the open position.

2. A food holder according to claim 1 wherein the front wall is provided with a retainer engageable with the steering wheel of a vehicle to retain the front wall in a position adjacent thereto.

3. A food holder according to claim 2 wherein the retainer comprises an elongated flexible member.

4. A food holder according to claim 3 wherein the elongated flexible member comprises a length of cord.

5. A food holder and vehicle steering wheel assembly wherein the food holder is in accordance with claim 2 wherein the retainer is engaged with the steering wheel to retain the front wall of the food holder in a position adjacent the steering wheel.

6. A food holder and steering wheel assembly according to claim 5 wherein the retainer comprises an elongated flexible member.

7. A food holder and steering wheel assembly according to claim 6 wherein the elongated flexible member comprises a length of cord.
